(19) United States
(12) Patent Application Publication
(10) Pub. No.: US 2003/0014146 A1
(43) Pub. Date: Jan. 16, 2003

(54) Dangerous process/pattern detection system and method, danger detection program, and semiconductor device manufacturing method

(75) Inventors: Osamu Fujii, Kanagawa-ken (JP); Tatsuo Akiyama, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: KABUSHIKI KAISHA TOSHIBA, Tokyo (JP)

(21) Appl. No.: 10/193,215

(22) Filed: Jul. 12, 2002

(30) Foreign Application Priority Data
Jul. 12, 2001 (JP) 2001-211748

(51) Int. Cl. G06F 19/00

(52) U.S. Cl. 700/121

(57) ABSTRACT

A system for detecting dangerous process/pattern includes: an input data processing unit configured to convert input data into formatted data; a critical condition storage unit configured to store critical conditions for defect generation; a universal simulation unit configured to perform at least process simulation for the formatted data and output those result as dangerous process determination-formatted data; and a mask simulation unit configured to perform mask simulation for the formatted data and output those result as dangerous pattern determination-formatted data. In addition, the system includes a dangerous process determination unit configured to compare the dangerous process determination-formatted data and the critical conditions, and determine whether it is a dangerous process; and a dangerous pattern determination unit configured to compare the dangerous pattern determination-formatted data and the critical conditions, and determine whether or not it is a dangerous pattern.

### CROSS REFERENCE TO RELATED APPLICATIONS

This application is based upon and claims the benefit of priority from prior Japanese Patent Application P2001-211748 filed on Jul. 12, 2001; the entirety of which is incorporated herein by reference.

### BACKGROUND OF THE INVENTION

1. Field of the Invention

The present invention relates to simulation techniques. In particular, it relates to a dangerous process/pattern detection system, dangerous process/pattern detection method, and danger detection program for detecting a dangerous process and/or dangerous pattern, and a method of manufacturing a semiconductor device using the same.

2. Description of the Related Art

In complex semiconductor device manufacturing and development that include combinations of several tens through several hundred manufacturing process steps, it is difficult to detect and avoid beforehand “dangerous processes” such as those which may cause crystalline defects to generate within the semiconductor device, as well as “dangerous patterns”, which are pattern layouts that may become the cause of such defects. In practice in cases where crystalline defects have been found following completion of the semiconductor manufacturing processes, causes are investigated by back-tracking through each of the manufacturing processes, and then developing counter-measures. As a result, time is wasted in semiconductor device manufacturing and development, and moreover, there are great losses from the standpoint of costs.

In order to avoid as much as possible the situation where defects are discovered after completion of a long and complex series of manufacturing processes, there has been heavy usage of, for example, doping profiles by the impurity diffusion using ion implantation, process simulation calculating the geometry deformation caused by the processes or by stress within the semiconductor, and device simulation using these results to determine the electrical characteristics. During these simulations, methods such as the finite element method, boundary element method, difference methods, or molecular dynamics are used.

However, the respective simulators (simulation devices) used for each of these simulations are each made specifically for finding the optimal solution for individual semiconductor manufacturing processes, and since there is no system for overall control of the simulators, it is difficult to efficiently detect a dangerous process and dangerous pattern of crystalline defect generation.

### SUMMARY OF THE INVENTION

A first aspect of the present invention is to provide a system for detecting a dangerous process/pattern. This system includes a) an input data processing unit configured to convert input data into formatted data; b) a critical condition storage unit configured to store critical conditions for defect generation; c) a universal simulation unit configured to perform at least process simulation for the formatted data and output those result as dangerous process determination-formatted data; d) and a mask simulation unit configured to perform mask simulation for the formatted data and output those result as dangerous pattern determination-formatted data. In addition, the system includes e) a dangerous process determination unit configured to compare the dangerous process determination-formatted data and the critical conditions, and determine whether or not it is a dangerous process; and f) a dangerous pattern determination unit configured to compare the dangerous pattern determination-formatted data and the critical conditions, and determine whether or not it is a dangerous pattern.

A second aspect of the present invention is to provide a computer-implemented method for detecting a dangerous process/pattern. The method includes a) converting input data into formatted data with an input data processing unit; b) performing at least process simulation for the formatted data and outputting those result as dangerous process determination-formatted data to a dangerous process determination unit; and c) comparing the dangerous process determination-formatted data and critical conditions stored in a critical condition storage unit to determine whether or not it is a dangerous process.

A third aspect of the present invention is to provide a computer program product for detecting dangerous process/pattern. This program includes a) a command for converting input data into formatted data with an input data processing unit; b) a command for performing at least process simulation for the formatted data and outputting those result as dangerous process determination-formatted data to a dangerous process determination unit; and c) a command for comparing the dangerous process determination-formatted data and critical conditions stored in a critical condition storage unit to determine whether or not it is a dangerous process. In addition, the program includes d) a command for performing mask simulation for the formatted data and outputting those result as dangerous pattern determination-formatted data to a dangerous pattern determination unit; and e) a command for comparing the dangerous pattern determination-formatted data and critical conditions stored in the critical condition storage unit, and determining whether or not it is a dangerous pattern.

A fourth aspect of the present invention is to provide a method of manufacturing a semiconductor device. The method includes a) performing at least one of process and mask simulations based on input data, determining whether or not it is a dangerous process or a dangerous pattern by comparing those result with critical conditions stored in a critical condition storage unit and setting modified input data in the case where there is a dangerous process or a dangerous pattern to obtain at least one of desired process condition and desired mask condition; and b) fabricating an integrated circuit on a semiconductor substrate based on obtained at least one of desired process condition and desired mask condition.

### BRIEF DESCRIPTION OF THE DRAWINGS

FIG. 1 is a block diagram of a dangerous process/pattern detection system according to an embodiment of the present invention;

FIG. 2 is a flowchart for a dangerous process/pattern detection system according to a first embodiment of the present invention;

FIG. 3 is an example of input data in the dangerous process/pattern detection system according to the first embodiment of the present invention;

FIG. 4 is an example of a dangerous pattern detection method in the dangerous process/pattern detection system according to the first embodiment of the present invention;

FIG. 5 is an example of process simulation results in the dangerous process/pattern detection system according to the first embodiment of the present invention;

FIG. 6 is an example of mask simulation results in the dangerous process/pattern detection system according to the first embodiment of the present invention;

FIG. 7 is an example of a schematic illustration of a semiconductor device;

FIG. 8 is an example of a planar view of mask pattern layout data for an element layout;

FIG. 9 is an example of a cross-sectional view of an element region;

FIG. 10 is a flowchart for a dangerous process/pattern detection system according to a second embodiment of the present invention;

FIG. 11A is an example of device simulation results in the dangerous process/pattern detection system according to the second embodiment of the present invention;

FIG. 11B is an example of device simulation results in the dangerous process/pattern detection system according to the second embodiment of the present invention; and

FIG. 12 is a flowchart showing the process flow of a semiconductor device manufacturing method according to an embodiment of the present invention.

### DETAILED DESCRIPTION OF THE INVENTION

Next, embodiments of the present invention are described while referencing the drawings. As written in the following drawings, the same or similar elements are given the same or similar reference numerals. Nevertheless, the drawings are meant to be schematic, and it should be noted that the each measurement may not be drawn to scale and may differ from that in actual usage. Accordingly, it is necessary to determine more specific measurements and the like while taking into consideration the following description. Naturally, it should also be noted that the relationship and scale of measurements among the various drawings may include portions that differ from each other.

(Dangerous Process/Pattern Detection System)

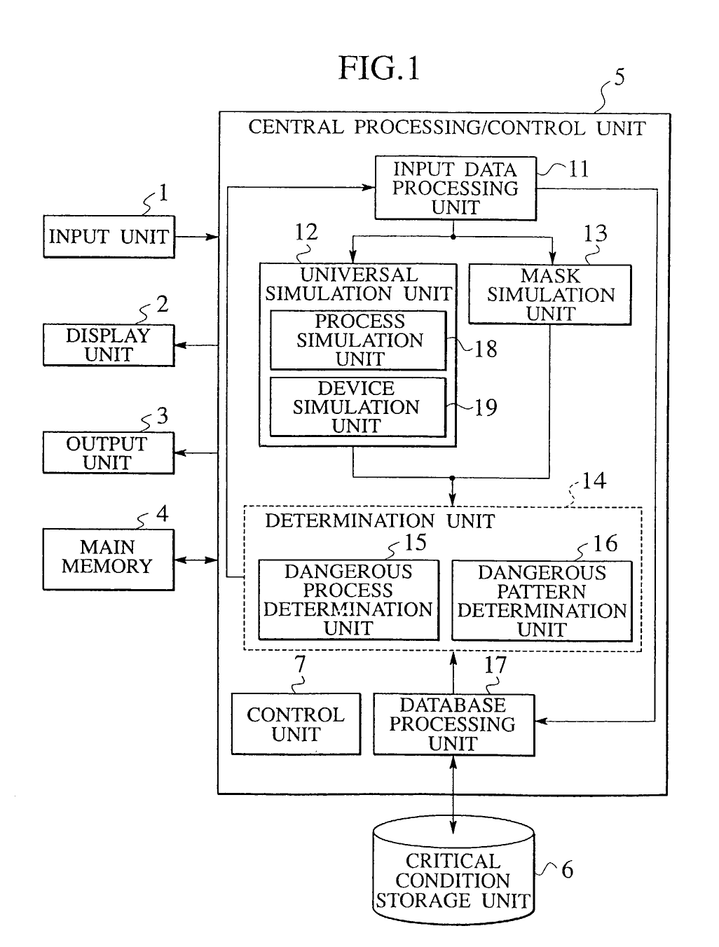

A dangerous process/pattern detection system according to an embodiment of the present invention is a system encompassing, as shown in FIG. 1, an input unit 1, a display unit 2, an output unit 3, a main memory 4, a central processing control unit (CPU) 5, and a critical condition storage unit 6. The CPU 5 is a processing control device executing the processing of the dangerous process/pattern detection system, and encompasses an input data processing unit 11, a universal simulation unit 12, a mask simulation unit 13, a determination unit 14, and a database processing unit 17.

The input unit 1 is a device inputting, for example, data regarding process conditions and data regarding mask conditions, and is implemented by, for example, a keyboard, a mouse, and/or a voice device. Input data to be input using the input unit 1 may include:

1) information regarding ion implantation conditions (i.e. accelerating voltage, ionic species, dosage, angle of implantation, etc.);

2) information regarding etching conditions (i.e. etching depth, trench width, angle of trench taper, name of material forming film to be etched, surface morphology, etching region coordinates, etc.);

3) information regarding anneal conditions (i.e. warm-up speed, cool-down speed, holding temperature, annealing time, ambient gas species, rate of ambient gas flow, etc.);

4) information regarding film deposition conditions (i.e. name of material to be deposited, warm-up speed, cool-down speed, holding temperature, hold time, type of source gas/carrier gas, rate of flow of these gasses, etc.);

5) information regarding the wafer (i.e. manufacturer, type of wafer, wafer diameter, wafer thickness, oxygen concentration within wafer, nitrogen concentration within wafer, wafer structure, etc.);

6) information regarding thin film physical properties (i.e. name of thin film material, Young's modulus, Poisson's ratio, coefficient of thermal expansion, intrinsic stress, coefficient of viscosity, physical property changing behavior due to heat, etc.);

7) information regarding the furnace used for anneal (i.e. name of the thermal processing system, temperature distribution, temperature change process, rate of ambient gas flow, location of ambient gas inflow, wafer support method, etc.);

8) information regarding the mask pattern layout (i.e. mask pattern coordinates, measurements, layout, process conversion difference, process conversion coefficient); and

9) data regarding locations where there is concern that crystalline defects may generate (i.e. coordinates, pattern layout, structure, etc.).

The display unit 2 is a device showing, for example, processing results from simulation, locations where input data is to be corrected, and reasons for defects (NG). The display unit 2 is implemented by, for example, a liquid crystal display (LCD) display or cathode-ray tube (CRT) display. The output unit 3 is implemented by an ink-jet printer, a laser printer, or the like. The main memory 4 is a device storing the various types of data such as the input data, process simulation results, mask simulation results, and program data, and may include read only memory (ROM) and random access memory (RAM). The ROM serves as, for example, program memory that stores risk detection programs for controlling the dangerous process/pattern detection system executed with the CPU 5. RAM serves as, for example, data memory that stores data used during program execution with the CPU 5 and may be utilized as a working region.

The input data processing unit 11 of the CPU 5 is a processing unit that automatically converts input data into, for example, formatted data for a desired simulation or formatted data for the critical condition storage unit 6. The universal simulation unit 12 encompasses a process simulation unit 18 and a device simulation unit 19. In addition, the universal simulation unit 12 encompasses a single simulator connected thereto, which performs calculation using the finite element method, boundary element method, difference methods, or molecular dynamics. Here, the universal simulation unit 12 may freely set which simulator is to be used for each process. The process simulation unit 18 executes a process simulation including changes of the doping file, the crystalline defect profile, change of the geometry ascribable to the stress within the semiconductor and the manufacturing process. The device simulation unit 19 inputs the results of the process simulation together with conditions such as current and voltage and executes a device simulation so as to determine the electrical characteristics of the device. The mask simulation unit 13 calculates the element shape of an arbitrary location for every manufacturing process from the mask pattern layout data.

The determination unit 14 detects and determines dangerous processes and dangerous patterns from the simulation results. The determination unit 14 encompasses a dangerous process determination unit 15 and a dangerous pattern determination unit 16. The determination unit 14 includes an update function for the critical condition storage unit 6. In a case where known critical conditions are avoided and crystalline defects generate, it is possible to update the critical condition storage unit 6 by performing a simulation once again with the input data with which the crystalline defects generated and setting each of the conditions as critical conditions. Moreover, since the critical conditions change depending on the process conditions, it is also possible to have settings that change for each process. The dangerous process determination unit 15 detects and determines a dangerous process from the simulation results of the universal simulation unit 12. The dangerous pattern determination unit 16 detects and determines a dangerous pattern from the simulation results of the mask simulation unit 13. The database processing unit 17 is an interface performing input/output to/from the input data processing unit 11, critical condition storage unit 6, and determination unit 14.

Moreover, the CPU 5 further includes a control unit 7, which controls the respective input/output to/from the input unit 1, display unit 2, output unit 3, main memory 4, input data processing unit 11, universal simulation unit 12, mask simulation unit 13, dangerous process determination unit 15, and database processing unit 17.

In addition, considering the load imposed on the CPU 5, the functions implemented by the CPU, namely the input data processing unit 11, universal simulation unit 12, mask simulation unit 13, dangerous process determination unit 15, dangerous pattern determination unit 16, and database processing unit 17, may be distributed to a plurality of computers thereby executing them. In the case where these functions are distributed among a plurality of computers, the computers may be connected to each other with a communication means such as a local area network or a telephone line to facilitate transfer of the input/output data.

The critical condition storage unit 6 is a storage device storing the critical conditions for defect generation. This critical condition storage unit 6 may be implemented by a storage device embedded within the dangerous process/pattern detection system, or alternatively, it may be structured in a critical condition storage unit server connected to a network.

(First Embodiment)

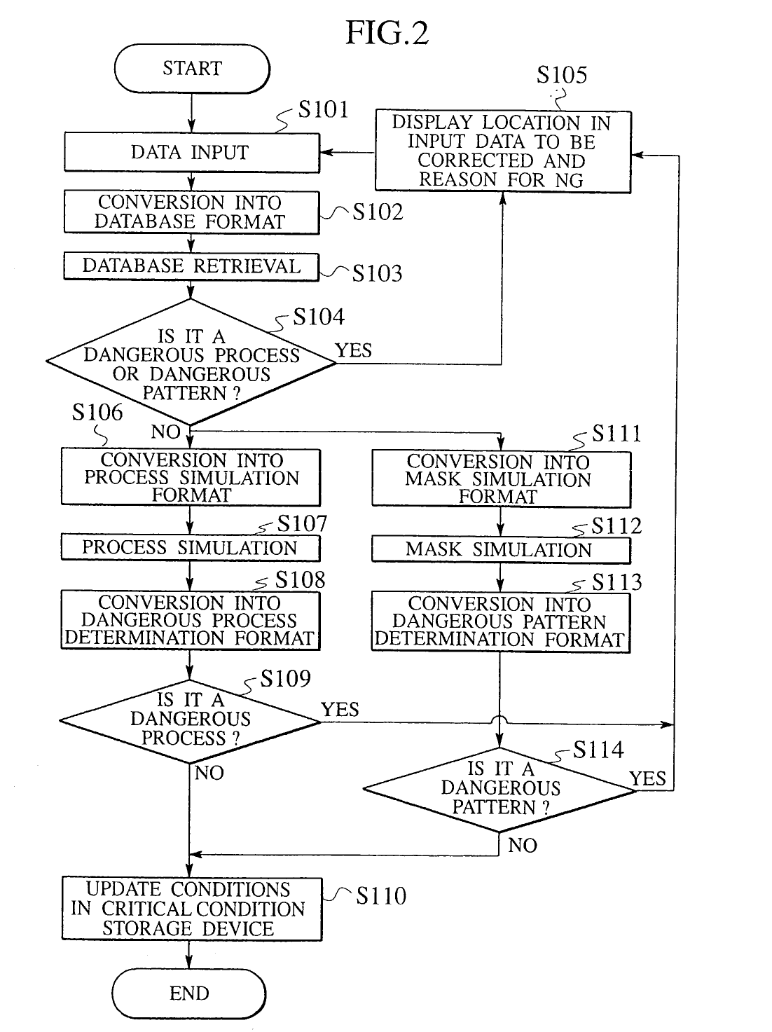

Next, the processing of the dangerous process/pattern detection system according to the first embodiment of the present invention is described while referencing FIG. 2.

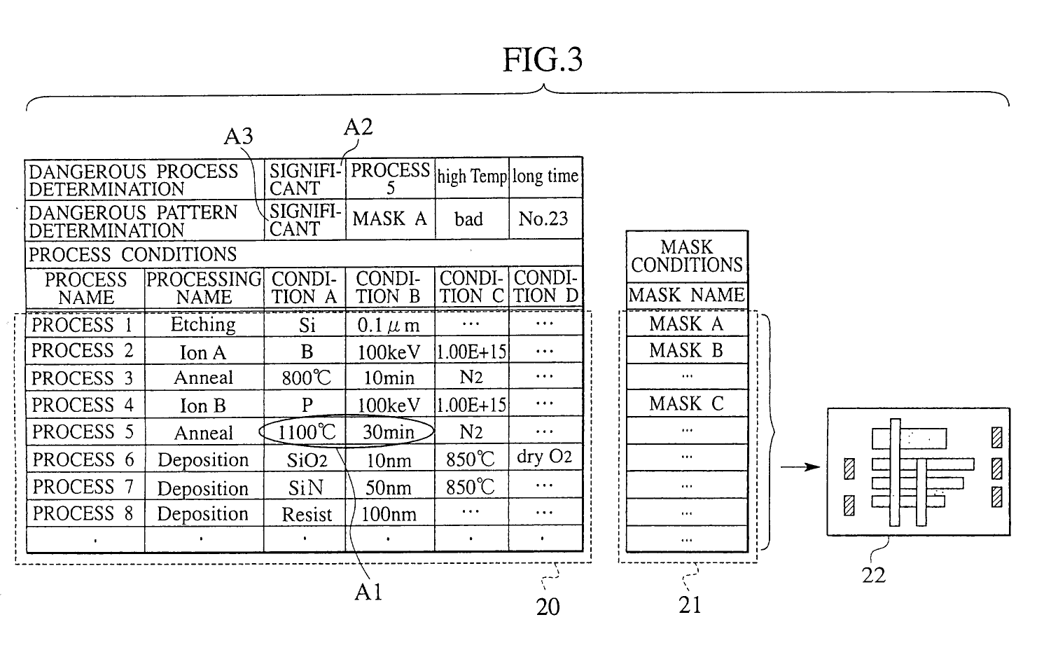

(a) In step S101, a user inputs input data into the input data processing unit 11 via the input unit 1. Here, as shown in FIG. 3, the input data includes, for example, data 20, which relates to the process conditions, data 21, which relates to the mask conditions, and mask pattern layout data 22. Data 20 relates to the process conditions, data 21 relates to the mask conditions, and mask pattern layout data 22 is data encompassing, for example, the conditions or sequence of a series of manufacturing processes, or the pattern layout or structure of a mask, according to the semiconductor device manufacturing process described earlier. It is possible to input dangerous processes and dangerous patterns besides the input data described above into the input data processing unit 11 as new items if the necessary information exists upon determination. Once data input is completed, processing proceeds to step S102 of FIG. 2.

(b) In step S102, the input data processing unit 11 performs the automatic conversion of the input data 20, 21, and 22 that has been input, into database-formatted data, and outputs this to determination unit 14.

(c) In step S103, database processing unit 17 retrieves the critical conditions (i.e. the dangerous pattern layouts, dangerous process conditions) from the database already registered and stored in the critical condition storage unit 6 in conformity with a request from the determination unit 14, extracts them, and outputs them to the determination unit 14.

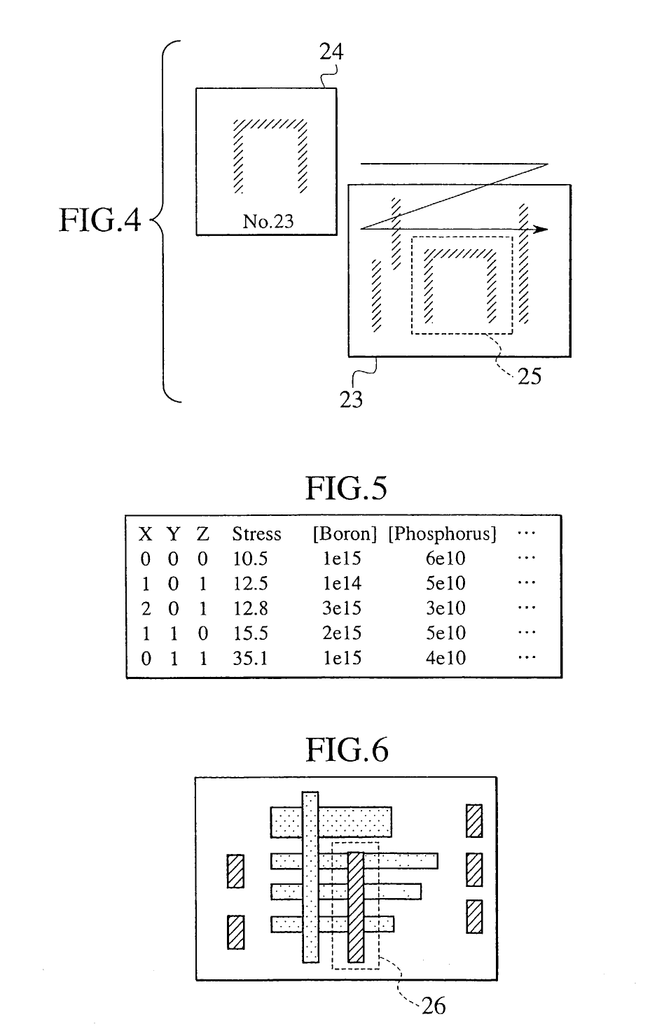

(d) In step S104, the determination unit 14 detects and determines dangerous processes and dangerous patterns by comparing the critical conditions retrieved and extracted from the critical condition storage unit 6 to the output database-formatted data. For example, in the case where a dangerous pattern is determined with regard to a mask pattern layout, as shown in FIG. 4, detection of a dangerous pattern 25 is performed through the overlay of input mask pattern layout data 23 with the dangerous pattern layout (critical condition) data 24 registered in the critical condition storage unit 6. It is possible to handle the mask pattern layout determination quantitatively by utilizing, for example, cross-correlation coefficients. If the determination unit 14 determines that there is a dangerous process or dangerous pattern, processing proceeds to step S105.

(e) In step S105, the input data processing unit 11 displays the locations to be corrected by the input data and the reasons for NG via the display unit 2, or alternatively, outputs them via the output unit 3. In other words, the process conditions or mask conditions determined to be a dangerous process or dangerous pattern are fed back into the input data processing unit 11. After confirmation of the display or output, processing returns to step S101. In light of the process conditions and mask conditions that have been fed back, the input data of, for example, the initially input process condition or mask condition is corrected or modified either manually or automatically so that the determination results of the dangerous processes and dangerous patterns are no longer be significant. For instance, regarding process conditions, in the case where the treatment temperature (1100° C.) and length of treatment time (30 min.) are initially input as shown in “A1” of the data 20 in FIG. 3, it is assumed that there is a past record of crystalline defect generation with those input values, and they are set as critical conditions in the critical condition storage unit 6. In such a case, the dangerous process determination unit 15 determines that this input data signifies a dangerous process, and as shown in the dangerous process determination column marked with “A2” in FIG. 3, informs the user through a display of either ‘SIGNIFICANT’ or of the degree of danger. In addition, in a case where mask pattern layout data 23 such as that shown in FIG. 4 is initially input, it is assumed that there is a past record of crystalline defects generated under those mask conditions, and they are set as the critical conditions, or more specifically the dangerous pattern layout data 24 in the critical condition storage unit 6. In such a case, the dangerous pattern determination unit 16 determines that this input data signifies a dangerous pattern, and as shown in the dangerous pattern determination column marked with “A3” in FIG. 3, informs the user through a display of either ‘SIGNIFICANT’ or of the degree of danger.

(f) Meanwhile, in the case where neither is determined a dangerous process nor a dangerous pattern in step S104, processing proceeds to either step S106 or step S111. In step S106, the input data processing unit 11 extracts the data regarding process conditions from the input data that was input in step S101 and automatically converts it to process simulation-formatted data. Following automatic conversion, processing proceeds to step S107. In other words, the process simulation-formatted data is output to the universal simulation unit 12.

(g) In step S107, the process simulation unit 18 in the universal simulation unit 12 conducts process simulations such as impurity profile, stress, and layout based on the process simulation-formatted data, and as shown in FIG. 5, outputs the process simulation results. Here, the output process simulation results may include, for example:

1) information relating to stress (i.e. normal stress in each direction, shear stress in each direction, resolved shear stress along the slip plane in the slip direction, Von Mises stress, principal stress, etc.);

2) information relating to impurities and defect concentration (i.e. interstitial element concentration, concentration of vacancies, or the concentration of impurities such as boron (B), arsenic (As), phosphor (P), or iron (Fe), etc.); and

3) information regarding geometry (i.e. depth (Z), width (Y), height (X), deposition form, etc.). In FIG. 5, the impurity concentrations of boron (B) and phosphorus (P) and stress are shown together with the geometry-related information (X, Y, Z). If other information is necessary besides the simulation results such as the above, it is also possible to obtain additional items, or if there is unnecessary information, it may be deleted.

(h) In step S108, the universal simulation unit 12 converts process simulation results into data formatted for dangerous process determination, and outputs the dangerous process,determination-formatted data to the determination unit 14.

(i) In step S109, the dangerous process determination unit 15 in the determination unit 14 determines whether or not it is a dangerous process based on the dangerous process determination-formatted data output in step S108. More specifically, the dangerous process determination unit 15 detects and determines a dangerous process by comparing simulation results with critical conditions for defect generation that are already registered and stored in the critical condition storage unit 6. In step S109, in the case where a dangerous process is determined, processing returns to step S105. More specifically, the dangerous process determination unit 15 feeds back to the input data processing unit 11 the process conditions that are determined as a dangerous process. It should be noted here that the process conditions that are determined as a dangerous process are temporarily stored in the main memory 4, and in step S110, to be described subsequently, used for updating the critical conditions in the database stored in the critical condition storage unit 6.

In step S105, the input data processing unit 11 then displays the locations to be corrected in the input data and the reasons for NG via the display unit 2, or outputs them via the output unit 3. Thereafter, processing returns to step S101, and in accordance with the process conditions that are fed back, correction or modification of the input data is performed automatically via the input unit 1.

(j) In the case where no dangerous process is determined, processing proceeds to step S110. In Step S110, the dangerous process determination unit 15 updates the database stored in the critical condition storage unit 6 via the database processing unit 17, based upon critical process conditions that are temporarily stored in the main memory 4 and that have been determined as a dangerous process, and finishes processing.

(k) Meanwhile, in step S111, the input data processing unit 11 extracts the data regarding mask conditions from the input data that was input in step S101 and automatically converts it to data formatted for mask simulation. The mask simulation-formatted data is then output to the mask simulation unit 13 and processing proceeds to step S112.

(l) In step S112, the mask simulation unit 13, first calculates element shapes at an arbitrary location by process from the mask pattern layout based on the mask simulation-formatted data. Then the mask simulation unit 13 outputs the layout data taking into consideration the process conversion difference for lithographic processes such as exposure and development and etching processes such as reactive ion etching (RIE). This layout data encompasses two-dimensional coordinate data upon the wafer surface and three dimensional coordinate data resulting from reading in processing data along the wafer thickness used for etching or deposition processes. Simulation is then performed using this coordinate data and the data of each process, mainly in regions designated within the input data and where there is concern regarding defect generation, and mask simulation results are output.

(m) In step S113, the mask simulation unit 12 converts mask simulation results into data formatted for dangerous pattern determination, and outputs the dangerous pattern determination-formatted data to the determination unit 14.

(n) In step S114, the dangerous pattern determination unit 16 in the determination unit 14 determines whether or not it is a dangerous pattern based on the dangerous pattern determination-formatted data output in step S113. More specifically, the dangerous pattern determination unit 16 detects and determines a dangerous pattern by comparing simulation results with the critical conditions for defect generation that are already registered and stored in the critical condition storage unit 6. In the case where a dangerous pattern 26 is determined in step S114, as shown in FIG. 6, processing returns to step S105. In other words, the dangerous pattern determination unit 16 feeds back the mask conditions determined to be the dangerous pattern 26 to the input data processing unit 11. It should be noted that here the mask conditions that are determined as a dangerous pattern are temporarily stored in the main memory 4, and in step S110, used for updating the critical conditions in the database stored in the critical condition storage unit 6. In step S105, the input data processing unit 11 then displays or outputs via the output unit 3 the locations of the input data to be corrected and the reasons for NG via the display unit 2. Moreover, processing returns to step S101, and in accordance with the process conditions fed back, correction or modification of the input data such as the mask pattern layout data initially input is performed automatically or manually via the input unit 1 so that no significant dangerous pattern determination remains.

(o) In the case where no dangerous pattern is determined in step S114, processing proceeds to step S110. In Step S110, the dangerous pattern determination unit 16 updates the critical condition within the database stored in the critical condition storage unit 6 via the database processing unit 17, based upon critical mask conditions that are temporarily stored in the main memory 4 and that have been determined as a dangerous pattern, and thus completes processing.

With this embodiment, in step S110, the critical conditions in the critical condition storage unit 6 are updated based upon critical process conditions determined as a dangerous process and critical mask conditions determined as a dangerous pattern. However, it is also possible for updating to take place at the step S109 and step S114 stages.

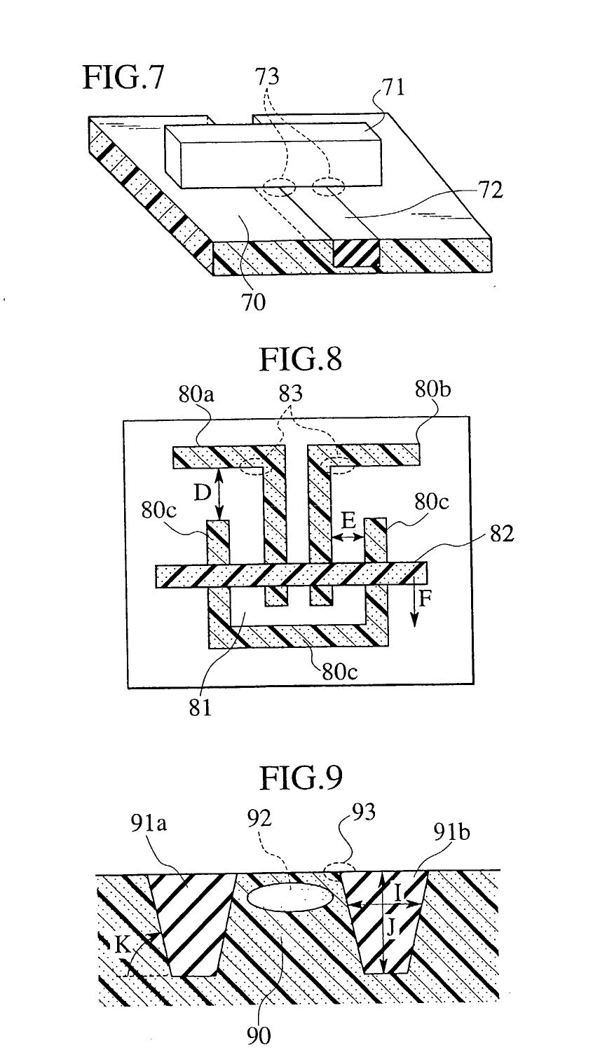

FIG. 7 is an example of a schematic illustration of a semiconductor device. As shown in FIG. 7, the semiconductor device includes a gate portion 71, which is disposed upon a silicon region 70, and a trench section 72, which is filled with a buried oxide film. At locations where the gate portion 71 and the trench portion 72 intersect (high stress regions 73), a possibility exists that the stress value of the critical conditions may be exceeded. If the critical condition stress level should be exceeded in the stress simulation, in a case where it is determined to be dangerous by the dangerous process/pattern detection system, it may be possible to avoid a dangerous determination by automatic or manual updating of input data including, for example, structural amounts such as the size of the gate portion 71, or physical property amounts such as the buried oxide film of the trench portion 72.

FIG. 8 is an example of a planar view of mask pattern layout data for the element layout. FIG. 8 shows a case where the mask pattern layout of the element layout includes rectangular silicon regions 80a and 80b, trench region 81, and gate region 82 deployed thereabove. There is a possibility that the critical condition stress level may be exceeded at the corners (high stress regions 83) of the rectangular silicon regions 80a and 80b. If the critical condition stress level is exceeded in the stress simulation and the dangerous process/pattern detection system determines it dangerous, automatic or manual updating of input data including, for example, width D of the trench portion 81, width E of the trench portion 81 or position F of the gate portion 82 is carried out, thereby avoiding a dangerous determination.

FIG. 9 is an example of a cross-sectional view of an element region. FIG. 9 shows that a silicon region 90, which becomes an active region, is interposed between two trench portions 91a and 91b, which are filled with a buried oxide layer. There is a possibility that the high impurity concentration region 92 on the top portion of the silicon region 90 may exceed the critical condition impurity concentration level. If it should be determined to be dangerous by the dangerous process/pattern detection system, it is possible for a dangerous determination to be avoided by an automatic or manual update of input data such as the level of ion implantation for the purpose of reducing the impurity concentration. In addition, in the case where the critical condition stress level is exceeded at the high stress region 93 of the upper corner of the silicon region 90 as a result of the stress simulation, and it is determined to be dangerous by the dangerous process/pattern detection system, it may be possible to avoid a dangerous determination by automatic or manual updating of input data including, for example, trench width I, trench depth J, or taper angle K of the trench side walls.

In a case where simulation results are determined as being dangerous as described above, it may be possible to perform process design that avoids crystalline defect generation on a simulation basis by performing simulation again after updating the input data. All of these studies may be performed in a computer. In addition, if the items to be changed are designated in advance, a sequence of danger-determination-avoidance operations may be automated.

Moreover, based on the orthogonal table of the Taguchi method or the design of experiment, by purposely having each input data include varying pieces of data, examination of the variation by which input items affect the critical conditions or defect generation may become possible, and decision of robust process conditions vis-à-vis the conditional variation may be made easier.

(Second Embodiment)

Processing of the dangerous process/pattern detection system according to the second embodiment of the present invention makes it possible to perform process design that avoids defect generation through ion implantation on a simulation basis.

For example, as ion implantation of arsenic (As) or phosphorus (P) is performed on a silicon substrate, depending on, for instance, the acceleration energy and dosage, the silicon crystals near the surface change into an amorphous layer. In addition, as a recrystallization anneal is being performed, a microscopic dislocation loop may form near the amorphous/crystal (a/c) boundary depending on, for example, annealing time and the type of ambient gas. When this microscopic dislocation loop exists within the depletion layer, since it acts as a recombination center, it becomes a cause of leakage current. As a result, in order to prevent leakage current, it is necessary to choose ion implantation conditions where microscopic dislocation loops do not generate. With the dangerous process/pattern detection system processing method according to the second embodiment, in a case where it is determined to be a dangerous process by referencing a crystalline defect database stored with information such as ion implantation conditions, it becomes possible to avoid defect generation through ion implantation by updating the ion implantation conditions.

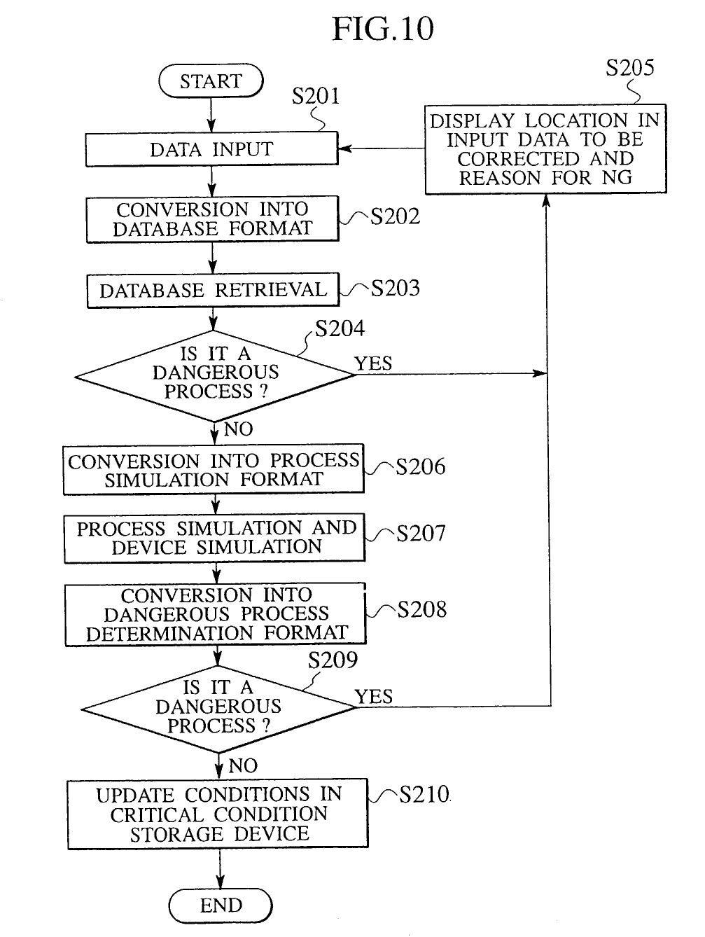

Next, the processing of the dangerous process/pattern detection system according to the second embodiment of the present invention is described while referencing FIG. 10.

(a) Instep S201, the user inputs the input data relating to process conditions into the input data processing unit 11 via the input unit 1. Here, the input data relating to process conditions includes information relating to ion implantation conditions (i.e. acceleration voltage, ionic species, dosage, angle of implantation, etc.) and information relating to anneal conditions (i.e. warm-up speed, cool-down speed, holding temperature, annealing time, type of ambient gas, rate of ambient gas flow, etc.). Once data input is completed, processing proceeds to step S202 of FIG. 10.

(b) In step S202, the input data processing unit 11 performs automatic conversion of the input data 20 that has been input, into database-formatted data, and outputs this to determination unit 14.

(c) In step S203, database processing unit 17 retrieves the critical conditions (dangerous process conditions) from the database already registered and stored in the critical condition storage unit 6 in conformity with a request from the determination unit 14, extracts them. Then, the database processing unit 17 outputs the critical conditions to the determination unit 14.

(d) In step S204, the determination unit 14 detects and determines dangerous processes by comparing the critical conditions retrieved and extracted from the critical condition storage unit 6 with the database-formatted data that was output. In step S204, in a case where the determination unit 14 determines that there is a dangerous process, processing proceeds to step S205.

(e) In step S205, the input data processing unit 11 displays the locations of the input data to be corrected and the reasons for NG via the display unit 2, or outputs them via the output unit 3. In other words, the process conditions determined as a dangerous process are fed back into the input data processing unit 11. After confirmation of display or output, processing returns to step S201. In light of the process conditions that have been fed back, the input data of, for example, the initially input process condition input data is corrected or modified either manually or automatically so that the result of the determination of the dangerous processes cannot be significant. For instance, in a case where the treatment temperature (1100° C.) and length of treatment time (30 min.) are initially input as shown in “A1” of the data 20 relating to process conditions in FIG. 3, it is assumed that there is a past record of crystalline defect generation with those input values, and they are set as critical conditions in the critical condition storage unit 6. In such a case, the dangerous process determination unit 15 determines that this input data signifies an at-risk process, and as shown in the dangerous process determination column marked with “A2” in FIG. 3, informs the user through either a display of ‘SIGNIFICANT’ or the degree of danger.

(f) Meanwhile, in the case where no dangerous process is determined in step S204, processing proceeds to step S206. In step S206, the input data processing unit 11 automatically converts the data related to process conditions that was input in step S201 into data formatted for process simulation. Following automatic conversion, processing proceeds to step S207. In other words, the process simulation-formatted data is output to the universal simulation unit 12.

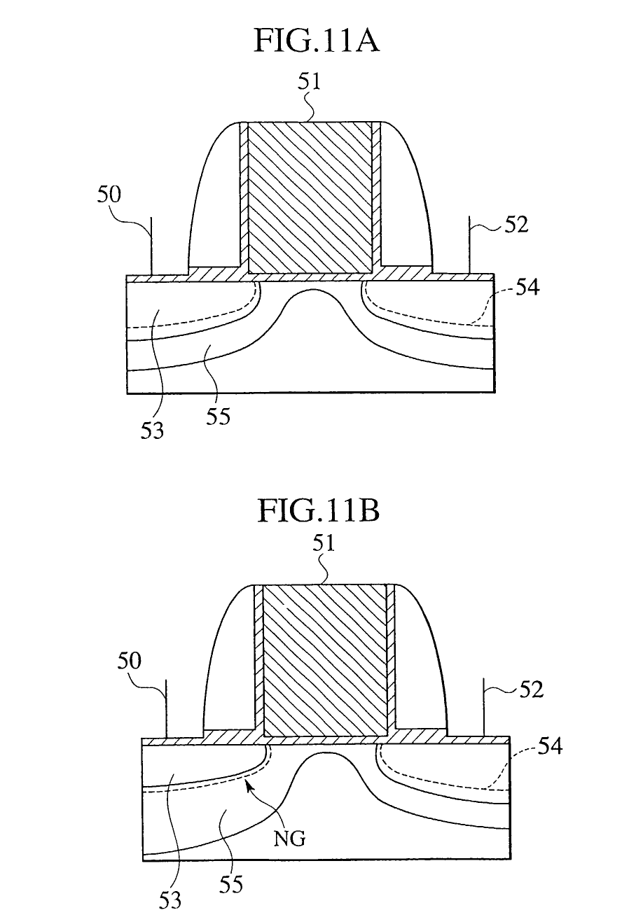

(g) In step S207, the process simulation unit 18 in the universal simulation unit 12 conducts process simulations such as impurity profile, stress, and layout based on the process simulation-formatted data, and outputs the process simulation results. Here, the output process simulation results may include the thickness of the amorphous layer, stress value for each directional component, interstitial silicon density, vacancy density, and the concentration of ion implantation. Moreover, the device simulation unit 19 in the universal simulation unit 12 inputs the results of the process simulation together with conditions such as current and voltage, performs device simulation to determine the electrical characteristics involved in, for example, forming the electrodes and causing the voltage to change, and outputs the device simulation results. FIGS. 11A and 11B are an example of the results of MOS transistor simulation. FIG. 11A shows a schematic illustration of a depletion layer 55 in a state where the voltage applied to the gate electrode 51 is zero, in a MOS transistor that includes a drain electrode 50, gate electrode 51, and source electrode 52. The state where there is no depletion layer 55 existing at the amorphous/crystal boundary 54, which was the boundary of the amorphous layer 53 and the single crystal is shown in FIG. 11A. FIG. 11B shows a schematic illustration of a depletion layer 55 region in a operating state where voltage is applied to the gate electrode 51 in the MOS transistor of FIG. 11A. FIG. 11B shows the fact that it is a dangerous process (NG) since there is a depletion layer 55 region existing at the amorphous/crystal boundary 54, which was the boundary of the amorphous layer 53 and the single crystal. The active region and the depletion region may be shown in such a manner.

If other information is necessary besides the simulation results as above, it is also possible to obtain additional items, or if there is unnecessary information, it may be deleted.

(h) In step S208, the universal simulation unit 12 converts process simulation results and device simulation results into data formatted for dangerous process determination, and outputs the dangerous process determination-formatted data to the determination unit 14.

(i) In step S209, the dangerous process determination unit 15 in the determination unit 14 determines whether or not it is a dangerous process based on the dangerous process determination-formatted data that is output. More specifically, the dangerous process determination unit 15 detects and determines a dangerous process by comparing simulation results with critical conditions for defect generation that are already registered and stored in the critical condition storage unit 6. In addition, the dangerous process determination unit 15 determines whether or not a depletion layer region exists at a location that was the boundary of the amorphous layer and crystal as the simulation result of step S207. Here, as shown in FIG. 11B, a dangerous process is determined when a depletion layer exists at the amorphous/crystal boundary 54, the boundary of the amorphous layer 53 and the crystal. Instep S209, when a dangerous process is determined, processing returns to step S205. In other words, the dangerous process determination unit 15 feeds back the process conditions determined as a dangerous pattern to the input data processing unit 22. It should be noted that here the process conditions that are determined as a dangerous process are temporarily stored in the main memory 4, and in step S210, used for updating the critical conditions in the database stored in the critical condition storage unit 6.

In step S205, the input data processing unit 11 then displays the locations of the input data to be corrected and the reasons for NG via the display unit 2, or outputs them via the output unit 3. Thereafter, processing returns to step S201, and in accordance with the process conditions that are fed back, correction or modification of the input is performed automatically via the input unit 1.

(j) In the case where it is determined as not being a dangerous process, processing proceeds to step S210. In Step S210, the dangerous process determination unit 15 updates the critical conditions in the database stored in the critical condition storage unit 6 via the database processing unit 17, based upon critical process conditions that are temporarily stored in the main memory 4 and that have been determined as a dangerous, and completes processing.

Here, information such as whether or not microscopic dislocation loops, defect concentration and dislocation of film edges such as gates exist and if so the respective concentration thereof for each ion implantation and each annealing condition are stored as a database in the critical condition storage unit 6, and may be referenced and updated. With this embodiment, in step S210, the critical conditions in the critical condition storage unit 6 are updated based upon critical process conditions determined as a dangerous process. However, it is also possible for updating to take place at the step S109 and step S114 stages.

In a case where simulation results are determined as being dangerous as described above, it may be possible to perform process design that avoids crystalline defect generation due to ion implantation on a simulation basis by again performing simulation after updating the data. All of these studies may be performed in a computer. In addition, if the items to be changed in the input data are designated in advance, a series of danger-determination-avoidance operations may be automated.

Moreover, based on the orthogonal table of the Taguchi method or the design of experiment, by purposely having each input data including varying pieces of data, examination of the variation by which input items affect the critical conditions or defect generation may become possible, and decision of robust process conditions vis-à-vis the conditional variation may be made easier.

(Danger Detection Program Product)

Next, details of a set of operational commands of a danger detection program product are described. A danger detection program product includes:

(a) a command for converting input data into database-formatted data, process simulation-formatted data, and mask simulation-formatted data with an input data processing unit.

(b) a command for comparing database-formatted data converted by the input data processing unit and critical conditions for defect generation stored in the critical condition storage unit, determining whether or not it is a dangerous process or a dangerous pattern, and in a case where it is a dangerous process or dangerous pattern, feeding back the process conditions or mask pattern layout conditions to the input data processing unit;

(c) a command for performing process simulation with the process simulation-formatted data converted by the input processing unit, and outputting the process simulation results as dangerous process determination-formatted data to the dangerous pattern determination unit;

(d) a command for performing mask simulation with the mask simulation-formatted data converted by the input processing unit, and outputting the mask simulation results as dangerous pattern determination-formatted data to the dangerous pattern determination unit;

(e) a command for comparing dangerous process determination-formatted data that is output with the critical conditions for defect generation stored in the critical condition storage unit, determining whether or not it is a dangerous process, and in the case where it is a critical process, feeding back the process conditions to the input data processing unit; and

(f) a command for comparing dangerous pattern determination-formatted data that is output with the critical conditions for defect generation stored in the critical condition storage unit, determining whether or not it is a dangerous pattern, and in the case where it is a critical pattern, feeding back the mask pattern layout conditions to the input data processing unit.

In addition, it is preferable that the danger detection program further includes a command for updating critical conditions in the critical condition storage unit, based upon critical process conditions determined as a dangerous process and critical pattern conditions determined as a dangerous pattern.

A danger detection program such as the above may be saved on computer readable storage media. The dangerous process/pattern detection system described above may be implemented through the reading of this storage media by the computer system shown in FIG. 1, and controlling the computer by executing the danger detection program. Here, storage media means media allowing a program to be stored, such as an external memory device of a computer, semiconductor memory, magnetic disk, optical disk, magneto-optical disk, or magnetic tape. More specifically, storage media may include flexible disks, compact disc read only memory (CD-ROM), magneto-optic (MO) disks, cassette tape, open reel tap, and the like.

(Semiconductor Device Manufacturing)

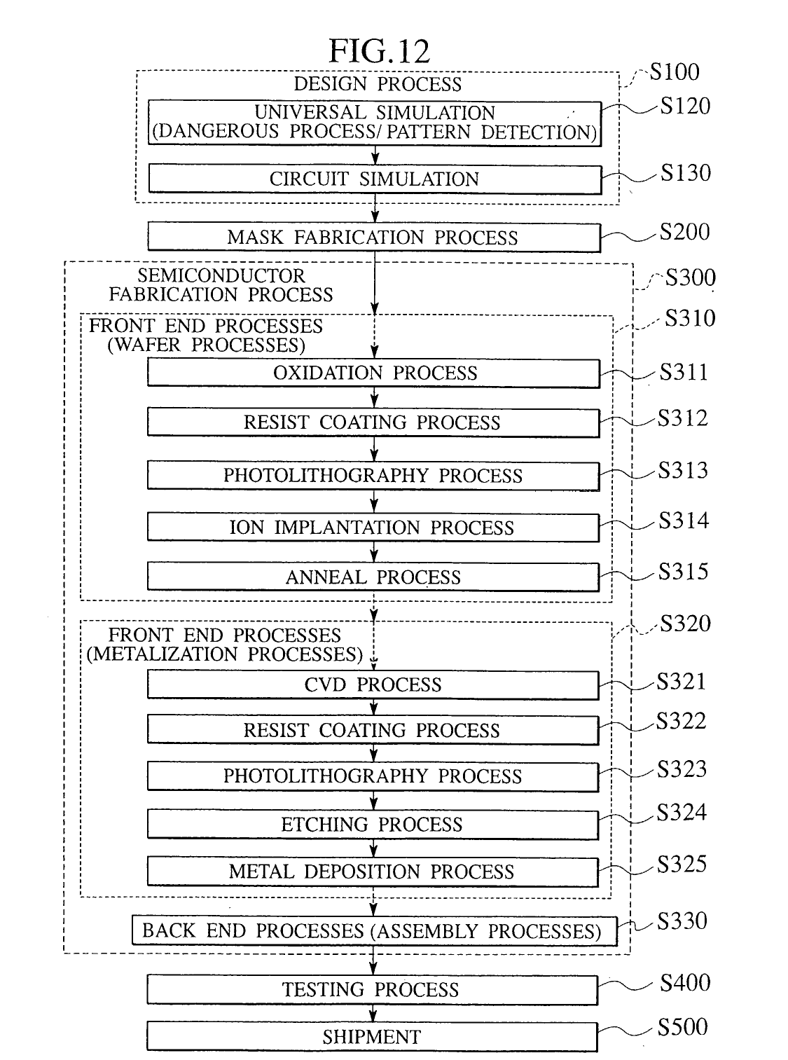

Next, a method for manufacturing a semiconductor device (LSI) using the dangerous process/pattern detection system described above is described while referencing FIG. 12. The method for manufacturing the semiconductor device according to the present invention, as shown in FIG. 12, embraces a design process occurring in step S100, a mask fabrication process occurring in step S200, and a semiconductor fabrication process occurring in step S300. The design step of step S100 includes a dangerous process and dangerous pattern detection step in step S110 and a circuit simulation step of step S130. The semiconductor fabrication step occurring in step S300 includes the front end processes (wafer processes) of step S310 and S320 for building in an integrated circuit upon a silicon wafer, and the back end processes (assembly processes) of step S330 from dicing to testing. In the following, each step is described in detail.

(a) To begin with, in step S120, comparison of the input data such as process conditions, mask conditions, and the like with the critical conditions already registered and stored in the critical condition storage unit 6 is performed using the dangerous process/pattern detection system according to the embodiments of the present invention described using the flowcharts in FIG. 2 and FIG. 10, and it is determined whether or not it is a dangerous process or a dangerous pattern. If neither a dangerous process nor a dangerous pattern is detected, process/mask simulation are carried out based on the requested specifications to determine the planar shape/cross-sectional geometry as well as impurity concentrations, defect concentrations and the like of the semiconductor device. If a dangerous process or a dangerous pattern is detected, it is fed back to the user, and the change or modification of the input data is carried out. Consequently, process/mask simulation by which a dangerous process and dangerous patterns are avoided is implemented. Moreover, if neither a dangerous process nor a dangerous pattern is detected, device simulation is performed based on the results of the process/mask simulation and each value of the electric current/voltage input to each electrode.

(b) Moreover, in step S130, LSI circuit simulation is performed using the electrical characteristics obtained from this device simulation and the circuit layout is determined (circuit simulation may be omitted).

(c) In step S200, the mask data for the number of masks necessary for creating an LSI surface pattern is generated, using a CAD system based on surface patterns such as the circuit layout decided upon in the design process of step S100. To begin with, taking into consideration the pattern conversion difference during the etching process and/or effect of the actual process such as the lateral spread of the diffusion region during the thermal diffusion process, the layout data of the mask level necessary for creating the surface pattern, determined by the design process of step S100, upon an actual semiconductor chip is generated. The layout data of this mask level may be produced in a number necessary depending on each process included in the front end processes of step S310. The number of masks produced may be anywhere from ten to several tens or even greater depending on the processes and the details of the semiconductor integrated circuit. Namely, the necessary pattern data for the reticles are respectively determined depending on each respective layer and the respective internal structures of the semiconductor chip. Moreover, using this reticle pattern data, a mask corresponding to each process may be delineated upon a mask substrate such as silica glass using a pattern generator such as an electron beam (EB) exposure system. Once the predetermined number of reticles is fabricated, mask testing is executed. If it is determined that a predetermined number of masks pass the mask testing, processing proceeds to step S310.

(d) Next, in step S310, substrate processes are carried out on a semiconductor wafer by repeating lithographic steps using the respective reticle necessary for each process. For instance, to describe a portion thereof, once predetermined processes have been passed, in step S311, it is assumed that a silicon oxide layer is formed through thermal oxidation upon the surface of a silicon substrate (oxidation process). Next, in step S312, a photoresist is applied onto the silicon oxide film (resist coating process). Thereafter, in step S313, a photolithography process is performed using the reticle fabricated in step S200, and the photoresist is exposed using a step and repeat method to perform patterning. This photoresist is used as a mask for ion implantation, and in Step S314, impurity ions are selectively implanted to the surface of the silicon substrate (ion implantation process). Then in step S315, following removal of the photoresist uses as the ion implantation mask, the implanted ions are activated through anneal, diffused to a predetermined depth, and an impurity doped region is formed inside the silicon substrate (anneal process). Hereafter, in the same manner, processes such as chemical vapor deposition (CVD) of a thin film such as a polycrystalline silicon and selective etching of this thin film using photolithography are continued. Once a necessary series of steps is completed, processing proceeds to step S320.

(e) Next, instep S320, metalization processing (surface interconnect process) is employed on the substrate surface by patterning a predetermined pattern with a stepper using the necessary reticle for each process in the same manner. For instance, to describe a portion thereof, in step S321, it is assumed that an interlayer insulating film is deposited through CVD upon a silicon wafer that has gone through each of the processes of step S310 (CVD process). Moreover, in step S322, a photoresist is applied upon the interlayer insulating film (resist coating process), and in step S323, this is exposed with a stepper using the corresponding reticle fabricated in step S200 to form an etching mask consisting of a photoresist (photolithography process). Then, in step S324, formation of a contact hole is performed in the interlayer insulating film by a selective etching process such as RIE using this etching mask (etching process). In step S325, the photoresist is removed, and following a surface wash, a metal such as tungsten is filled into the contact hole using vacuum evaporation or sputtering or the like. Thereafter, again, anew etching mask is delineated by a photolithographic process and this metallic layer is patterned. Moreover, another interlayer insulating film is deposited upon this patterned metallic film and similar processes are repeated.

(f) Once the necessary multi-level interconnect structure is completed and the front end processes (wafer processes) are completed, in Step S330, dicing into a predetermined chip size is performed (dicing process) by a dicing machine such as a diamond blade. These are then mounted on a packaging material such as metal or ceramics (mounting process), and following connection of the electrode pad upon the chip with the lead of the lead frame with gold wiring (bonding process), predetermined package assembly processing such as plastic molding is implemented (molding process).

(g) In step S400, after passing through predetermined testing such as performance testing related to the performance/functioning of the semiconductor device and lead shape/measurement status and reliability testing (testing process), the semiconductor device is completed.

(h) In Step S500, the semiconductor device that has cleared all of the above processes is encapsulated to protect against moisture and static electricity and shipped out.

As described above, according to the method of manufacturing a semiconductor device of the embodiments of the present invention, since a manufacturing process and mask patterns for preventing the generation of crystalline defects are employed, reductions in yield may be avoided. As a result, the turnaround time for new product development may be shortened and production costs may be reduced.

According to the dangerous process/pattern detection system, dangerous process/pattern detection method, danger detection program, and semiconductor device manufacturing method of the embodiments of the present invention, design of semiconductor process conditions and/or mask pattern layout that avoid crystalline defect generation becomes possible. In addition, setting of robust semiconductor process conditions against the conditional variation of semiconductor device processes or mask pattern layouts may be made easier. Moreover, dangerous process and/or dangerous pattern detection accuracy in semiconductor manufacturing may be improved and decreases in yield due to crystalline defects may be avoided.

In the preceding, the present invention is described in detail through the embodiments; however, it is obvious to those with ordinary skill in the art that the present invention is not meant to be construed as being limited by the description of this embodiment in this application. The device of the present invention may be implemented with various improvements and modifications without going outside the scope or theme of the present invention determined by the description of the scope of the patent claims. Accordingly, the description of the present invention aims to provide merely an exemplary description, and is not to be construed as limiting the present invention in any way.

What is claimed is:

1. A system for detecting a dangerous process/pattern, comprising:
an input data processing unit configured to convert input data into formatted data;
a critical condition storage unit configured to store critical conditions for defect generation;
a universal simulation unit configured to perform at least process simulation for the formatted data and output result thereof as dangerous process determination-formatted data;
a mask simulation unit configured to perform mask simulation for the formatted data and output result thereof as dangerous pattern determination-formatted data;
a dangerous process determination unit configured to compare the dangerous process determination-formatted data and the critical conditions, and determine whether or not it is a dangerous process; and
a dangerous pattern determination unit configured to compare the dangerous pattern determination-formatted data and the critical conditions, and determine whether or not it is a dangerous pattern.

2. The system of claim 1, wherein the universal simulation unit comprises:
a process simulation unit configured to perform process simulation; and
device simulation unit configured to perform device simulation for finding the electrical characteristics of a device.

3. The system of claim 1, wherein
the mask simulation unit calculates an element shape at an arbitrary location for each manufacturing process based on mask pattern layout data.

4. The system of claim 1, wherein
the input data includes data relating to process condition or mask condition, and mask pattern layout data.

5. The system of claim 1, wherein
the dangerous process determination unit and the dangerous pattern determination unit update critical conditions of the critical condition storage unit, based upon process condition determined as a dangerous process and mask condition determined as a dangerous pattern.

6. A computer implemented method for detecting a dangerous process/pattern, comprising:
converting input data into formatted data with an input data processing unit;
performing at least process simulation for the formatted data and outputting result thereof as dangerous process determination-formatted data to a dangerous process determination unit; and
comparing the dangerous process determination-formatted data and critical conditions stored in a critical condition storage unit, and determining whether or not it is a dangerous process.

7. The computer implemented method of claim 6, wherein
process simulation and device simulation is performed for the formatted data and results thereof are output as the dangerous process determination-formatted data to the dangerous process determination unit.

8. The computer implemented method of claim 6, wherein
the input data is data relating to process conditions including information relating to ion implantation and anneal conditions.

9. The computer implemented method of claim 6, further comprising:
updating critical conditions of the critical condition storage unit, based upon process condition determined as a dangerous process.

10. The computer implemented method of claim 6, further comprising:
before performing the process simulation, determining whether or not it is a dangerous process by referencing the input data and critical conditions stored in the critical condition storage unit.

11. The computer implemented method of claim 6, further comprising:
performing mask simulation for the formatted data and outputting result thereof as dangerous pattern determination-formatted data to a dangerous pattern determination unit; and
comparing the dangerous pattern determination-formatted data and critical conditions stored in the critical condition storage unit, and determining whether or not it is a dangerous pattern.

12. The computer implemented method of claim 11, wherein
the input data includes data relating to process condition or mask condition, and mask pattern layout data.

13. A computer implemented method for detecting a dangerous process/pattern, comprising:
converting input data into formatted data with an input data processing unit;
performing mask simulation for the formatted data and outputting result thereof as dangerous pattern determination-formatted data to a dangerous pattern determination unit; and
comparing the dangerous pattern determination-formatted data and critical conditions stored in a critical condition storage unit, and determining whether or not it is a dangerous pattern.

14. The computer implemented method of claim 13, wherein
through the mask simulation, an element shape at an arbitrary location for each manufacturing process are calculated based on mask pattern layout data.

15. The computer implemented method of claim 13, further comprising:
updating critical conditions of the critical condition storage unit, based upon mask condition determined as a dangerous pattern.

16. A computer program product to be executed by a computer for detecting a dangerous process/pattern, comprising:
a command for converting input data into formatted data with an input data processing unit;
a command for performing at least process simulation for the formatted data and outputting result thereof as dangerous process determination-formatted data to a dangerous process determination unit;
a command for comparing the dangerous process determination-formatted data and critical conditions stored in a critical condition storage unit, and determining whether or not it is a dangerous process.
a command for performing mask simulation for the formatted data and outputting result thereof as dangerous pattern determination-formatted data to a dangerous pattern determination unit; and
a command for comparing the dangerous pattern determination-formatted data and critical conditions stored in the critical condition storage unit, and determining whether or not it is a dangerous pattern.

17. The computer program product of claim 16, further comprising:
a command for updating critical conditions of the critical condition storage unit, based upon process condition determined as a dangerous process and mask condition determined as a dangerous pattern.

18. A method for manufacturing a semiconductor device comprising:
performing at least one of process and mask simulations based on input data, determining whether or not it is a dangerous process or a dangerous pattern by comparing the result thereof with critical conditions stored in a critical condition storage unit and setting modified input data in the case where there is a dangerous process or a dangerous pattern to obtain at least one of desired process condition and desired mask condition; and
fabricating an integrated circuit on a semiconductor substrate based on obtained at least one of desired process condition and desired mask condition.

19. The method of claim 18, further comprising:
after determining a pattern layout that should be formed upon the semiconductor substrate based on the desired mask condition, preparing a necessary number of reticles for each manufacturing process using an exposure system, in accordance with mask pattern data generated based on the determined layout; and wherein
the fabricating the integrated circuit on the semiconductor substrate comprising a series of fabrication processes including a first photolithographic process using one of the reticles, a selective diffusion process using a diffusion mask obtained in the first photolithographic process, a second photolithographic process using another one of the reticles, a selective etching process using an etching mask obtained in the second photolithographic process.

20. The method of claim 18, wherein
the input data includes data relating to process condition or mask condition, and mask pattern layout data.
